(19) United States
(12) Patent Application Publication
(10) Pub. No.: US 2015/0022008 A1
(43) Pub. Date: Jan. 22, 2015

(54) HOME BASE STATION FOR MULTIPLE ROOM COVERAGE WITH MULTIPLE TRANSMITTERS

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 13/946,065

(22) Filed: Jul. 19, 2013

(51) Int. Cl. H02J 5/00; H02J 7/02

(52) U.S. Cl. CPC H02J 5/005; H02J 7/025
USPC 307/104

(57) ABSTRACT

The present disclosure may provide a wireless power system which may be used to provide wireless power transmission (WPT) while using suitable WPT techniques such as pocket-forming. Wireless power system may include a single base station which may be connected to several transmitters. Base station may manage operation of every transmitter in an independently manner or may operate them as a single transmitter. Connection between base station and transmitters may be achieved through a plurality of techniques including wired connections and wireless connections. In some embodiments, transmitters may include one or more antennas connected to at least one radio frequency integrated circuit (RFIC). Base station may include at least one microcontroller and a power source. In other embodiments, transmitters may include a plurality of antennas, a plurality of RFIC or a plurality of controllers. In addition, transmitters may include communications components which may allow for communication to various electronic equipment including phones, computers and others.

### CROSS-REFERENCES TO RELATED APPLICATIONS

The present disclosure is related to U.S. Non-Provisional patent application Ser. No. 13/891,430 filed May 10, 2013, entitled “Methodology For Pocket forming”; Ser. No. 13/891,455 filed May 10, 2013, entitled “Transmitters For Wireless Power Transmission”; and Ser. No. 13/925,469 filed Jun. 24, 2013, entitled “Methodology for Multiple Pocket-Forming” the entire contents of which are incorporated herein by these references.

### FIELD OF INVENTION

The present disclosure relates to electronic transmitters, and more particularly to portable transmitters for wireless power transmission.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging. Current solutions to this problem may include inductive pads which may employ magnetic induction or resonating coils. Nevertheless, such a solution may still require that electronic devices may have to be placed in a specific place for powering. Thus, electronic devices during charging may not be portable.

For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present disclosure provides a portable wireless transmitter which can be utilized for wireless power transmission using suitable techniques such as pocket-forming. Transmitters may be employed for sending Radio frequency (RF) signals to electronic devices which may incorporate receivers. Such receivers may convert RF signals into suitable electricity for powering and charging a plurality of electric devices. Wireless power transmission allows powering and charging a plurality of electrical devices without wires.

A method for wireless power transmission comprises the steps of providing at least one base station including a micro-controller connected to a power source, and connecting multiple transmitters to the base station having pocket-forming capabilities for generating pockets of energy to power an electronic device within range of at least one of the multiple transmitters.

Wireless power system may include several transmitters located in different locations for enabling multiple rooms coverage. In order to improve this feature, a single base station may manage each transmitter in different location with different and independent operation modes. Furthermore, base stations may enable the use of all transmitters as a single transmitter.

Base stations may reduce the cost of a wireless power system, because specific circuitry may only be placed in base stations rather than on each transmitter. In addition, the use of a base station for controlling several transmitters may improve the managing and charging of several receivers.

Numerous other aspects, features and benefits of the present disclosure may be made apparent from the following detailed description taken together with the drawings provided.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a wireless power transmission example situation using pocket-forming.

FIG. 2 illustrates a component level embodiment for a wireless power system including three transmitters.

FIG. 3 illustrates a wireless power system including 2 transmitters in two different rooms.

FIG. 4 illustrates a wireless power system including 2 transmitters plugged into light sockets in two different rooms.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

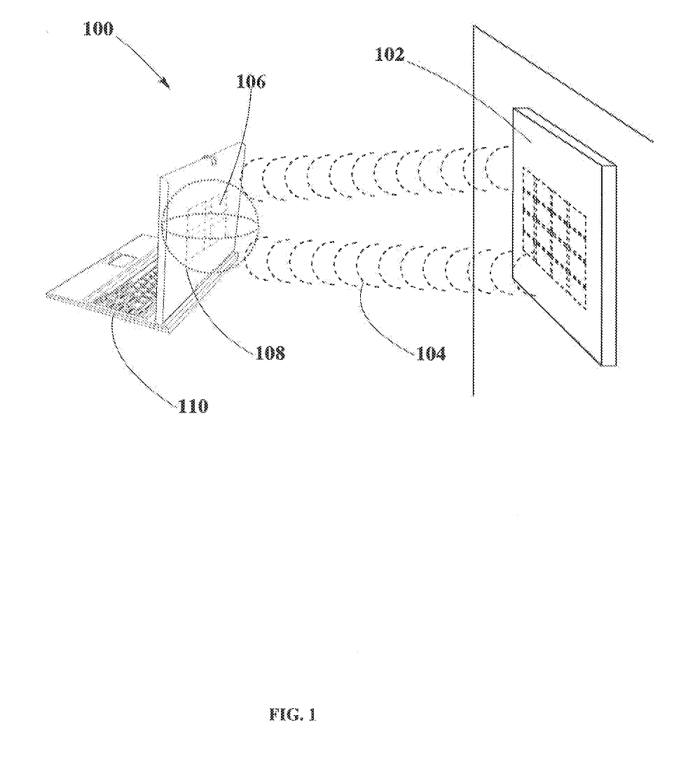

FIG. 1 illustrates wireless power transmission 100 using pocket-forming. A transmitter 102 may transmit controlled Radio RF waves 104 which may converge in 3-d space. These Radio frequencies (RF) waves may be controlled through phase and/or relative amplitude adjustments to form constructive and destructive interference patterns (pocket-forming). Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless power transmission 100. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

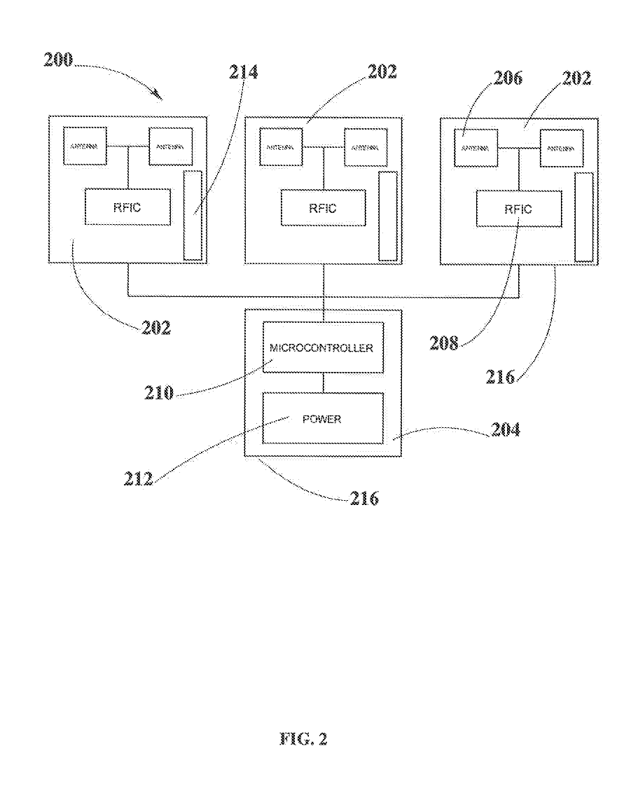

FIG. 2 depicts a block diagram of a wireless power system 200, which may include a plurality of wireless power transmitter 202 connected to a single base station 204. transmitters 202 may include one or more antenna elements 206, one or more Radio frequency integrated circuit (RFIC) 208, a communication component 214 and a housing 216, which may allocate all the components previously mentioned. Base station 204 may include one or more microcontroller 210, a power source 212 and a housing 216, which may allocate all the components previously mentioned. Components in wireless power system 200 and base station 204 may be manufactured using meta-materials, micro-printing of circuits, nano-materials, and the like.

Base station 204 may be located, in variety of locations where transmitters 202 may stay connected to it. Such connection may include a variety of connections, which may include coaxial cable, phone cable, LAN cable, wireless connection among others. The connection between base station 204 and transmitters 202 aims to establish a link between RFC 208 and microcontroller 210, as well as the power source 212 connection.

Microcontroller 210 may control a variety of features of RFIC 208 such as, time emission of pocket-forming, direction of the pocket-foming, bounce angle, power intensity and the like. Furthermore, microcontroller 210 may control multiple pocket-forming over multiple receivers 106 or over a single receiver 106. In addition, microcontroller 210 may manage and control communication protocols and signals by controlling communication component 214. Thus microcontroller 210 may drive the foregoing features in several transmitters 202 at the same time.

Base station 204 may be fed by a power source 212 which in turn may feed to transmitters 202. Power source 212 may include AC or DC power supply. Voltage, power and current intensity provided by power source 212 may vary in dependency with the required power to be transmitted. Conversion of power to radio signal may be managed by microcontroller 210 and carried out by RFIC 208, which may utilize a plurality of methods and components to produce radio signals in a wide variety of frequencies, wavelength, intensities and other features. As an exemplary use of a variety of methods and components for radio signal generation, oscillators and piezoelectric crystals may be used to create and change radio frequencies in different antenna elements 206. In addition, a variety of filters may he used for smoothing signals as well as amplifiers for increasing power to be transmitted.

Furthermore, RFIC 208, microcontroller 210, communication component 214 and the rest of electronic components may be built in solid state circuits for increasing reliability in wireless power system 200. Others techniques for increasing reliability of electronic components may be used.

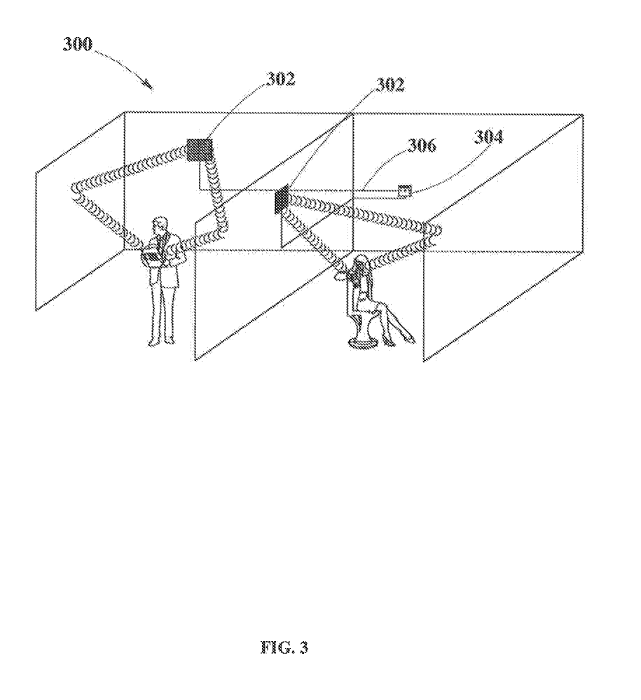

FIG. 3 depicts a wireless power system 300, which may include 2 transmitters 302, a base station 304 and connections 306.

Base station 304 may enable operation of different transmitters 302 in different rooms or area coverages. Each transmitter 302 may operate at different frequencies, power intensities and different ranges. In addition, each transmitter 302 may provide power to a plurality of receivers 106. Furthermore, base station 304 may enable a single operation of all transmitter 302, thus may provide a higher capability for wireless charging by the use of each transmitter 302 as a single one.

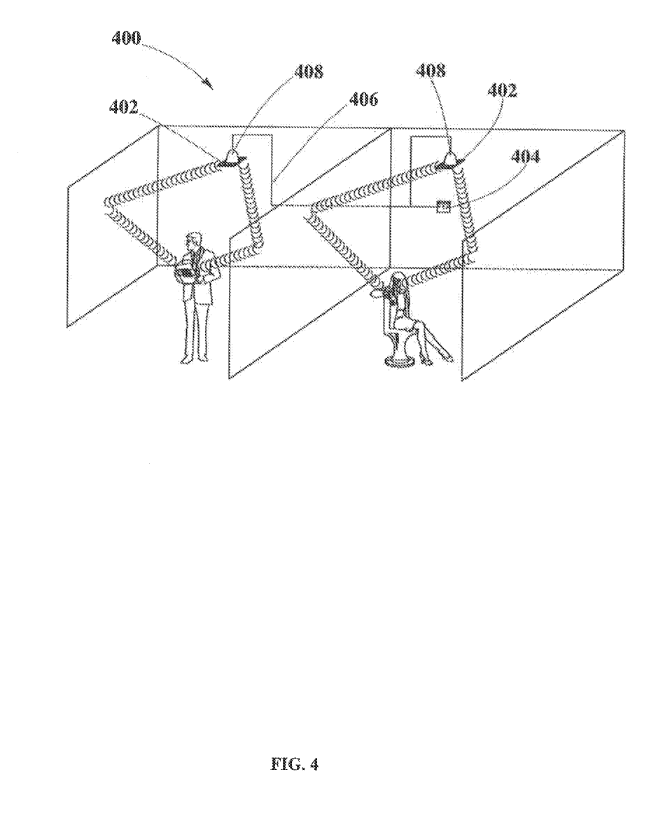

FIG. 4 depicts a wireless power system 400, which may include 2 transmitters 402, a base station 404 and connections 406.

Base station 404 may enable operation of different transmitters 402 in different rooms or area coverages. Each transmitter 402 may operate at different frequencies, power intensities and different ranges. In addition, each transmitter 402 may provide power to a plurality of receivers 106. Furthermore, base station 404 may enable a single operation of all transmitter 402, thus may provide a higher capability for wireless charging by the use of each transmitter 402 as single one.

In addition, transmitters 402 may be plugged into light sockets 408. Such light sockets 408 may increase the places where transmitters 402 may be installed.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

Having thus described the invention, I claim:

1. A method for wireless power transmission, comprising the steps of:
providing at least one base station including a micro-controller connected to a power source; and
connecting multiple transmitters to the base station having pocket-forming capabilities for generating pockets of energy to power an electronic device within range of at least one of the multiple transmitters.

2. The method for wireless power transmission of claim 1, wherein the base station includes a housing for the micro-controller and the power source.

3. The method for wireless power transmission of claim 1, wherein each of the portable transmitters includes antenna elements, a radio frequency integrated circuit for the pocket-forming, and a communication component for communicating with the electronic device within range to determine powering levels.

4. The method for wireless power transmission of claim 3, wherein each of the multiple transmitters includes a housing for the circuitry and components.

5. The method for wireless power transmission of claim 1, further includes the step of establishing a link between the base station and multiple transmitters through a connection including coaxial cable, phone cable, LAN cable, Wi-Fi or other wireless connection.

6. The method for wireless power transmission of claim 3, further comprising the step of communicating between the electronic device receiver and the transmitter through short RF waves or pilot signals on conventional wireless communication protocols including Bluetooth, Wi-Fi, Zigbee or FM radio signal with the power level information for the electronic device to be charged.

7. The method for wireless power transmission of claim I, further comprising the step of adjusting dynamically the pocket-forming to regulate power on one or more targeted electronic device within range of the multiple transmitters.

8. The method for wireless power transmission of claim 1, wherein the multiple transmitters are capable of powering multiple receivers connected to portable electronic devices including smartphones, tablets, music players, toys, game consoles and other similar devices wherein the transmitters are providing different powering or charging levels corresponding to the electronic device being powered within the range of the multiple transmitters.

9. The method for wireless power transmission of claim 4, wherein components of the base station and the multiple transmitters are manufactured from meta-materials, micro-printing of circuits, nano-materials and other similar materials for integrated chips.

10. The method for wireless power transmission of claim 1, wherein the pocket-forming within the transmitters is controlled by a radio frequency integrated circuit utilizing components including oscillators and piezoelectric crystals to create and change radio frequencies in different antenna elements connected to the radio frequency integrated circuit.

11. The method for wireless power transmission of claim 1, wherein the micro-controller in the base station enables different transmitters of the multiple transmitters in different rooms or coverage areas in which each transmitter operates at a different frequency, different power intensity and different range to power the selected electronic device.

12. The method for wireless power transmission of claim 1, wherein the base station and multiple transmitters are built in solid state circuits to increase reliability.

13. The method for wireless power transmission of claim 1, wherein the multiple transmitters are plugged into a light socket in a room for a power source.

14. The method for wireless power transmission of claim 1, wherein each transmitter operates at different frequencies, power intensities and different ranges to power the electronic device.

15. A wireless power transmission, comprising:
a base station having a micro-controller and a power source; and
multiple transmitters electrically connected to the base station having pocket-forming capabilities for generating pockets of energy to power an electronic device within range of at least one of the multiple transmitters.

16. The wireless power transmission of claim 15, wherein the base station includes a housing for the micro-controller and the power source.

17. The wireless power transmission of claim 15, wherein each of the portable transmitters includes antenna elements, a radio frequency integrated circuit for the pocket-forming, and a communication component for communicating with the electronic device within range to determine powering levels.

18. The wireless power transmission of claim 15, wherein the electronic device communicates power requests to the transmitters for charging through communication protocols of Bluetooth, Wi-Fi, Zigbee or radio FM signals.

19. The wireless power transmission of claim 15, wherein the base station is electrically connected to the multiple transmitters through a connection including a coaxial cable, a phone cable, a LAN cable, a Wi-Fi or another wireless connection.

20. The wireless power transmission 15, wherein each transmitter powers a plurality of receivers embedded within the electronic device and wherein the base station enable a single of operation of the multiple transmitters to provide a higher capability for wireless charging by using several transmitters to act as a single charging transmitter with regard to the electronic device being charged.
